(19) United States
(12) Patent Application Publication
(10) Pub. No.: US 2007/0233587 A1
(43) Pub. Date: Oct. 4, 2007

(54) Method for monitoring and monetizing an investment security

(76) Inventor: Christopher M. Unrath, New York City, NY (US)

Correspondence Address: SQUIRE SANDERS & DEMPSEY LLP, TWO RENAISSANCE SQUARE, 40 NORTH CENTRAL AVENUE, SUITE 2700, PHOENIX, AZ, 85004-4498, US

(21) Appl. No.: 11/392,208

(22) Filed: Mar. 28, 2006

(51) Int. Cl. G06Q 40/00

(52) U.S. Cl. 705/36 R

(57) ABSTRACT

The invention provides a method for monitoring and monetizing an investment security in a business. An investment entity provides capital in return for a share of business entity's revenue. Preferably, the business entity is a potential or current licensee or franchisee of a licensed or franchised business that would be under the obligation to pay a licensor or franchisor a fee that also is based, at least partially, on revenue. In this way, the share of the business entity's revenue received by the investment entity may be validated by comparing it to a revenue-based fee paid to a third-party (i.e., the licensor or franchisor).

### FIELD OF THE INVENTION

The present invention relates to a method for monitoring and monetizing an investment security in a business, and more specifically, to a method for monitoring and monetizing smaller-sized investments using a revenue-based security for a franchised or similarly licensed business.

### BACKGROUND OF THE INVENTION

Finding adequate investment vehicles for private equity is a difficult task. Investments are typically researched to determine the viability of the business, quality of the management, relevant market pressures, cost structures, expected profit and growth, and expected investment monetization/exit opportunity. As this research process is often time consuming and expensive, it is typically only undertaken to analyze higher growth and/or higher value businesses.

In addition to the potential for higher levels of absolute profits resulting from completing larger investments relative to smaller investments, there are other reasons that private equity investors pursue larger investments rather than smaller investments. Larger businesses are often easier to evaluate than smaller businesses because the relevant issues that can affect a larger business are often fewer and more visible than those for a smaller business. Smaller business investment opportunities are often passed over as the cost of the research desired to determine the profitability of the business and quality of the management is relatively large with respect to the absolute level of returns an investor may expect.

Frustratingly, this situation has resulted in virtually no professionally managed and aggregated private equity being available for individuals who desire to purchase a franchised or licensed business. This lack of private equity not only hinders potential franchisees and licensees, but also hinders franchisors and licensors. Often, the most qualified person to run a franchise or licensed business (e.g., a former employee or manager) may not be in the financial position to purchase the franchise or licensed business without private equity or other funding.

### SUMMARY OF THE INVENTION

In view of the foregoing, the invention provides a method for monitoring and monetizing an investment security in a business.

In exchange for capital from an investment entity, a business entity transfers equity shares and a revenue participation right in the business entity. The revenue participation right sets a schedule of payments to be made to the investment entity at predetermined intervals. These revenue participation payments are based on the revenue of the business. By basing the payments on revenue, the quality of the management, relevant market pressures, expected profit and growth of the business, accounting policies, cost structure of the business, and efficiency of the operations become less important to the decision to invest in the business. In addition, since the revenue of a business is generally easier to monitor and verify, fraud against an investor becomes more difficult to commit. Also, this feature lowers and may eliminate some of the tension that can exist between business operator and investor by lessening the investor's interest in issues such as compensation, accounting policies and procedures, and management of other expenditures.

The revenue participation payments are preferably comprised of two portions. One percentage of the revenue participation payment is classified as a dividend while the other percentage of the revenue participation portion is used to redeem a portion of the equity shares that were transferred to the investment entity. Preferably, the revenue participation right is structured to last the longer of a predetermined period of time or a time when the transferred equity shares have been redeemed. As a result of the allocation of payments to redeem equity, the owner of the business entity has a clear path to full ownership of the business, while the investment entity has a clear to path to monetizing their investment with substantially lower concerns regarding any potential sales of the business. In addition, an investor is able to make a smaller investment because he is relieved of the responsibility of finding another investor to purchase his share of the business. Also, the owner of the business entity is incentivized to make the revenue-based payments because each payment increases their ownership share. As such, investors have a lower need to monitor the business.

Preferably, the method of the invention is used when investing in a franchised or licensed business. Franchised and licenses businesses typically have a third party (i.e., a franchisor or licensor) that performs significant oversight of the franchised or licensed business. Such third parties often have highly developed systems for monitoring the revenue of such businesses because often a large percentage of their own revenue is dependent on their ability to collect their own royalty share based on the business entity's revenue. As such, the investment entity's need to perform independent oversight or revenue monitoring is lessened, the risk that it will not collect its proper share of revenue is lowered, and its operating costs may be reduced. As such, the revenue-based payments received by the investment entity may be evaluated relative to the fees paid to the third party (i.e., the licensor or franchiser) to verify that the investment entity receives the pre-agreed share of revenue. This lessens the need for the investment entity to closely monitor and/or audit the financial records of the business entity to verify that the payments they receive are in the correct amount.

According to one aspect, the invention provides a method for monitoring and monetizing an investment security. The method includes the step of entering into a security agreement with a business entity, wherein the agreement includes a provision that specifies a schedule of one or more payments. The one or more payments are based on a revenue of the business entity. The method further includes the steps of receiving a payment of the one or more payments, receiving a statement of fees paid to a third party by the business entity, wherein the fees paid to third party are at least partly based on the revenue of the business entity, and comparing the fees paid to the third party to the received payment to confirm that the received payment is of an amount specified in the security agreement.

According to another aspect, the invention provides a method for monetizing an investment security. The method includes the steps of entering into a security agreement with a business entity, wherein security agreement provides equity shares and a revenue participation right in exchange for capital, receiving a payment based on revenue in accordance with the revenue participation right, and redeeming a portion of the equity shares with a portion of the payment.

It is to be understood that the descriptions of this invention herein are exemplary and explanatory only and are not restrictive of the invention as claimed.

### BRIEF DESCRIPTION OF THE DRAWINGS

FIG. 1 depicts the flow of information, agreements, and payments according to one embodiment of the invention.

FIG. 2 depicts the method steps for monitoring and monetizing an investment security according to one embodiment of the invention.

FIG. 3 depicts the method steps for monetizing an investment security according to another embodiment of the invention.

FIG. 4 depicts an example report to show cash flow between the business entity and the investment entity according to one embodiment of the invention.

FIG. 5 depicts an example report used to calculate the RPS payment due according to one embodiment of the invention.

FIG. 6 depicts an example report used to show the number of shares that are retired with a cash payment according to one embodiment of the invention.

FIG. 7 depicts an example report used to show the change in equity as a result of retiring shares according to one embodiment of the invention.

FIG. 8 depicts an example report used to show the history of RPS activity according to one embodiment of the invention.

FIG. 9 depicts an example report used to give notice that part of the RPS payment is being deferred according to one embodiment of the invention.

FIG. 10 depicts an example report used to show the number of deferral events that have occurred according to one embodiment of the invention.

FIG. 11 depicts an example report used to update the status of deferrals according to one embodiment of the invention.

FIG. 12 depicts an example report used to show a liquidity forecast according to one embodiment of the invention.

FIG. 13 depicts an example used when the Revenue Participation Share (RPS) payment is settled through the issuance of equity according to one embodiment of the invention.

### DESCRIPTION OF THE EMBODIMENTS

Reference will now be made in detail to the present exemplary embodiments of the invention, examples of which are illustrated in the accompanying drawings.

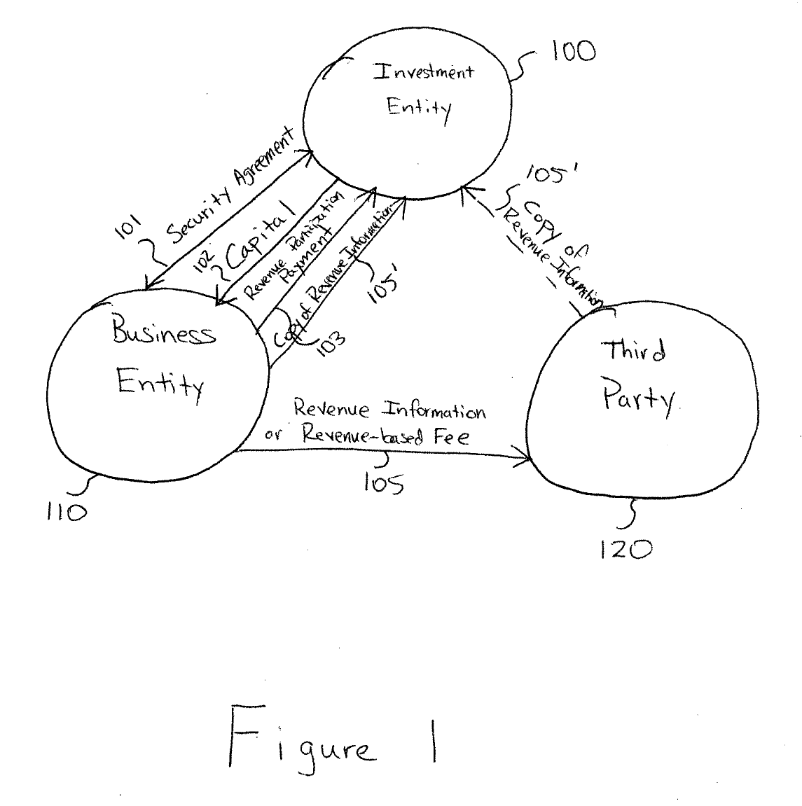

The invention provides a method for monitoring and monetizing an investment security in a business. FIG. 1 depicts the flow of information, agreements, and payments according to one embodiment of the invention. In general, an investment entity 100 enters into a security agreement 101 with a business entity 110. The investment entity 100 provides capital 102 to the business entity 110 in return for an equity interest in the business and a share of the business entity's revenue. This share of revenue is paid to the investment entity 100 in revenue participation payments 103.

Preferably, the business entity 110 is a potential or current licensee or franchisee of a licensed or franchised business that would be under the obligation to pay a third party 120 (e.g., a licensor or franchisor) a fee or provide information 105 that also is based on revenue. A copy 105′ of this fee (e.g., in the form of a cancelled check) or information 105 is provided to the investment entity 100 by the business entity 110 or by the third party 120. In this way, the share (i.e., the revenue participation payment) 103 of the business entity's 110 revenue received by the investment entity 100 may be confirmed to be the amount agreed upon in the security agreement 101 by comparing it to a revenue-based fee or information 105 provided to a third-party 120 (e.g., a licensor or franchisor).

Because the franchisor or licensor has a monetary interest in the correctness of the revenue-based fee paid to them, the veracity of the revenue reported to them and the correctness of any revenue-based fee paid to them generally has greater validity than situations where businesses have no such oversight. Typically, franchisors and licensors have processes in place to monitor, oversee, and audit their franchisors and licensors. As such, the accuracy of the revenue-based payments made to the investment entity may be confirmed by checking the payment against revenue-based information or fees provided to such a third party licensor or franchisor. This reduces the risk of the investment entity's investment and may also lower their internal costs. A copy of the revenue-based information provided to the third party may be forwarded to the investment entity in any form. Preferably, the information provided is a statement of the revenue-based fee paid to a third-party in the form of a copy of a cancelled check.

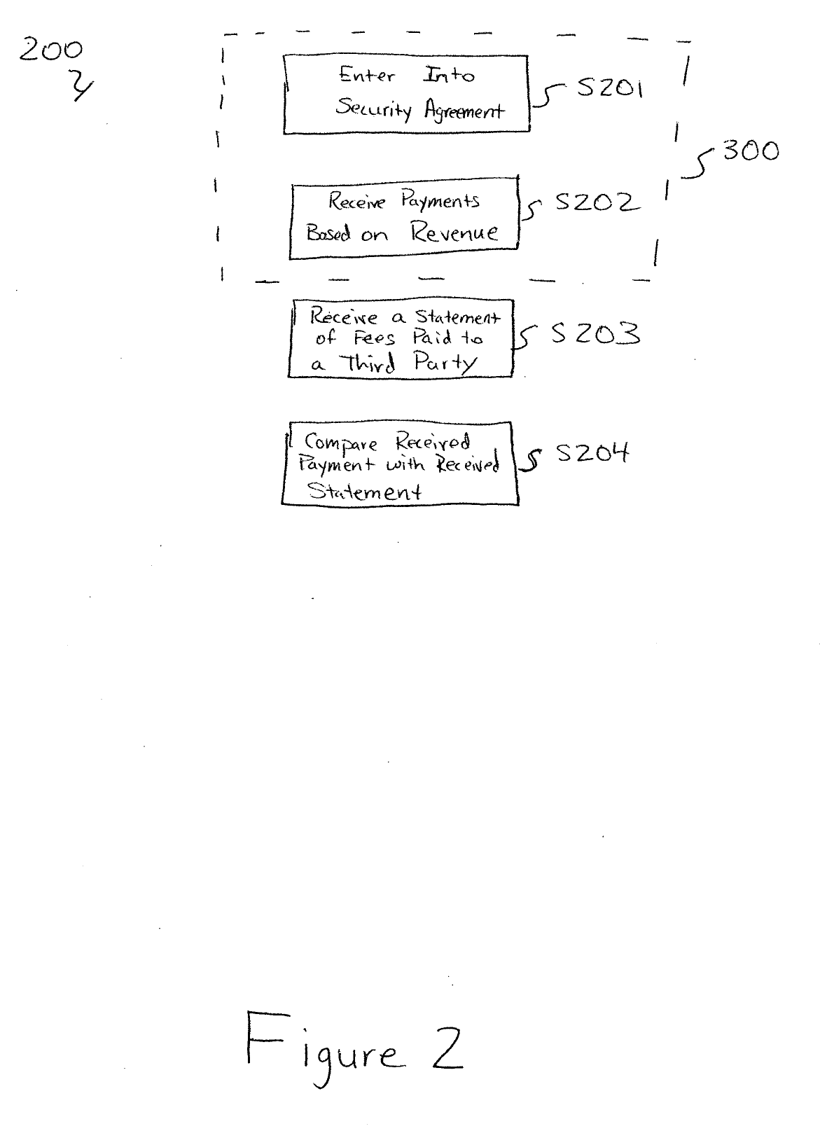

FIG. 2 depicts the method steps for monitoring and monetizing an investment security according to one embodiment of the invention. The method 200 of this embodiment includes the step of entering into a security agreement with a business entity, wherein the agreement includes a provision that specifies a schedule of one or more payments (S201). The one or more payments are based on the revenue of the business entity. The method further includes the steps of receiving a payment of the one or more payments (S202), receiving a statement of fees paid to a third party by the business entity (S203), wherein the fees paid to third party are at least partly based on the revenue of the business entity, and comparing the fees paid to the third party to the received payment to confirm that the received payment is of an amount specified in the security agreement (S204).

In step S201, a security agreement is entered into with a business entity. The security agreement may be any type of agreement, such as a stockholders agreement or contract. The security agreement specifies that, in return for capital, the business entity grants an investment entity (i.e., the entity that provided the capital) the right to share in the revenue of the business entity. This revenue is to be paid to the investment entity through one or more payments. As the capital is provided in exchange for a share in revenue, it would be considered to be an equity investment rather than a loan or debenture.

The business entity may be structured in any format. For example, the business entity may be a sole proprietorship, partnership, limited liability partnership, limited liability corporation, corporation etc. However, the business entity should be of a type that is under an obligation to provide a statement of revenues and/or a revenue-based fee to a third party. In this regard, the business entity is preferably a current or potential franchisee or licensee in a franchised or licensed business. In such a case, the third party to which they would be obligated to provide a revenue statement or revenue-based fee would be the franchisor or licensor whom would have a system to monitor revenue. Preferably, the business entity would be under an obligation to pay a revenue-based fee to a franchisor or licensor at regular intervals. In such situations, franchisors or licensors often have systems and method for monitoring and verifying the revenue of business entities.

The capital received by the business entity may be used for any purpose acceptable to the parties. For example, in the case of a franchised or licensed business, the capital may be used to pay the initial franchise/license fee, to purchase equipment, or to serve as working capital.

The investment entity may be any entity that supplies capital to the business entity. This may include an individual investor, mutual fund company, investment bank, hedge fund, etc.

As indicated above, the security agreement provides the investment entity with a right to share in the revenue of the business entity through one or more revenue based payments (S202). This right to a share in revenue is called the Revenue Participation Share (“RPS”). The RPS is easier to monitor than conventional profit-based equity arrangements as it is revenue-based. This feature lowers and may eliminate some of the tension that can exist between business operator and investor by lessening the investor's interest in issues such as compensation, accounting policies and procedures, and management of other expenditures. Sharing in revenue is also highly “auditable” which simplifies investment oversight. That is, revenue is generally easier to verify and predict than profit, as it depends on many fewer factors and is less susceptible to varying interpretations of accounting policy and attempts at fraud.

The RPS entitles the investment entity to receive a negotiated portion of the revenue of the business entity. Preferably, the RPS is paid to the investment entity through of one or more payments at predetermined intervals. For example, the payments may be monthly, quarterly, or yearly, however, any payment interval may be used. The percentage of revenue to be paid in each of the payments may depend on a variety of factors, such as 1) revenue size of business 2) perceived volatility of the revenue 3) amount of money invested 4) what other capital sources the business entity is using. Preferably, the percentage of revenue specified by the RPS is somewhere between 0.5% to 8%. However, the RPS may specify any percentage of revenue to be paid to the investment entity that does not put the business entity in jeopardy. Other factors that may be considered when agreeing to a percentage of the RPS are based on general perceptions of risk and may 1) management quality 2) product offering 3) brand name and 4) demographics and location.

In addition to the RPS, the security agreement also preferably transfers equity shares of the business entity to the investment entity. Preferably, the equity shares are in the form of preferred stock which is convertible into common stock. However, any type of equity, including common stock or partnership interests, may be transferred to the investment entity.

As one example, the equity shares transferred by the security agreement may be convertible preferred equity in the face amount of the investment (i.e., the provided capital) made by the investment entity. Such convertible preferred equity is typically convertible (at the holder's option) into common equity (e.g., commons stock) at the issuance price per share of the common stock.

In embodiments where the security agreement transfers equity shares to the investment equity, the RPS is preferably, structured in two portions. One portion of the RPS may be classified as a dividend, while the remaining portion of the RPS payment is used to redeem a portion of the equity shares transferred to the investment equity. The percentage of the RPS devoted to dividends and equity redemption may vary in each security agreement and may be structured in any ratio.

Preferably, the RPS (i.e., the right to share in revenue) is retired at the end of a predetermined length of time and upon redemption of all of the transferred equity shares. In this case, the security agreement guarantees the investment entity a right to share in revenues for a predetermined length of time, regardless of whether all the equity shares have been redeemed. If some of the transferred equity shares remain outstanding at the end of the predetermined length of time, the investment entity continues to share in revenues until all the outstanding equity shares have been redeemed. The predetermined length of time for sharing in revenue may vary for each business entity and may be any length of time. Preferably, the RPS length is long enough so that the rate and absolute level of return obtained through the RPS payments is meaningful to the investment entity. As one possible example, the right to share in revenue may be guaranteed for five years. Once the RPS is retired, the investment entity no longer has a right to share in revenue nor has an equity position in the business entity. As such, the investment of capital has been monetized and the business entity is free of encumbrances from the investment entity.

To the extent possible, it would be preferable for an investment entity that has security agreements with multiple business entities to have consistent terms across its portfolio of investments. However, the economic terms of each financing will reflect factors affecting perception of risk, including the business entity's financial commitment to the project, the market in which operations will occur, and the overall operating projections.

RPS Example

Assume that an investment entity provides $200,000 to a business entity to fund one franchised business requiring $300,000 of equity capital. The security agreement provides for the investment entity to own equity shares (e.g., convertible preferred equity) with a face value of $200,000 and the RPS. The convertible equity may be converted into 66% of the common equity of the business entity (200,000/300,000).

By the terms of the security agreement, the RPS entitles the investment entity to receive 6.5% of the revenue of the franchised business so long as the RPS is outstanding. Assuming the store generates revenue of $1,000,000 annually, the revenue share paid to the investment entity would be $65,000 ($1,000,000×6.5%). Per the terms security agreement, thirty-three percent ($21,450) of the $65,000 RPS payment would be applied to redeem the equity shares outstanding (thereby reducing the capital senior to the business entity and directly reducing the investment entity's potential common equity interest). The remaining percentage of the RPS (67%) would be considered a dividend. The specific accounting for this distribution is a dividend of $43,550 and a capital redemption of $21,450.

The redemption of $21,450 of equity shares in year one reduces the investment entity's potential common equity interest from 66% at the time of investment origination to 60%. Under these assumptions, in one year the founding entrepreneur's equity has increased 17.7% (600 basis points) as a result of the automatic redemption feature associated with the RPS payment.

The above process would occur until such time as the 33% share redemption allocation of the RPS payments reduced the balance of the equity shares to zero and the predetermined length of time for the RPS has run (e.g., 5 years). In this example, the equity shares are reduced to zero when $600,000 of RPS payments have been made ($600,000×33%=$200,000 [the original amount of convertible preferred equity outstanding]).

Deferred RPS Payment

The previous example assumed that the business entity would be able to pay the RPS at each of the predetermined intervals. However, in some situations, the business entity may be unable to pay. In this regard, the RPS is structured to be part of a preferred equity claim, and is not a debt security. Failure by the business entity to make a payment required under the terms of the RPS cannot cause an event of default as would a failure to pay a debt obligation.

However, the RPS may be structured such that in the event payments due under the terms of the RPS are not made for a specified period (e.g., six months), the payment that would be due after the specified period, to the extent it is not paid in cash, can then be applied by investment equity to acquire additional equity shares.

As one example, assume that after the third anniversary, the investment equity's original equity position has been reduced, through application of 33% of the RPS payments, from 67% to 45%. If the business entity has determined that payments due under the RPS would jeopardize the operating liquidity of the business entity and the suspension of such payments (assume $5,417 per month based on $65,000 annual RPS payment) extends into a seventh cumulative month, then the investment entity's equity interest in the business entity would increase in month seven from 45% to 46.8% (66.6% original ownership position divided by $200,000 original investment, times the $5,417 RPS payment).

Other Methods of Equity Redemption

In addition to the RPS ending “naturally” through the full redemption of equity shares and the RPS payments for the length of time specified in the security agreement, the security agreement may provide for the business entity to have a call option to purchase all outstanding equity shares from the investment equity.

As one example, the business entity may, after the predetermined length of time for RPS payments (e.g., on the fifth anniversary), acquire all or part of the investment entity's equity shares. The RPS revenue participation right (the distribution of 6.5% of revenue to the investment entity) would remain fully in force so long as any portion of the equity shares remains outstanding.

In addition, the security agreement may also provide for the investment entity to have a put right to sell any outstanding equity shares after the predetermined time for RPS payments.

Redemption of the equity shares per the 33% allocation under the RPS payment occurs at the issuance price (i.e., the value the business entity assigned to each share), as shown in the example above. Preferably, the redemption of equity shares under the terms of either the business entity's call right, or the investment entity's put right, occurs at the greater of the issuance price or a formula-based value.

Call/Put Example

One example of how the call/put rights work is as follows: Assume the business entity has had five years of identical operations of $1,000,000 of annual revenue. By the fifth year of operation, the RPS will have generated revenue participation payments of $325,000 (five payments of $65,000, or 6.5% of $5 million). Per the terms of the RPS, thirty-three percent of the $325,000 of revenue participation payments, $107,250, will have been applied to reduce investment entity's preferred equity ownership from $200,000 to $92,750. The reduction in equity shares results in the investment entity's potential common equity interests being reduced from 66% at the time of capitalization to 31% at the end of five years. The owner's (of the business entity) equity ownership increased 73%, from 40% to 69% of the fully diluted common equity.

At this point the owner of the business entity may seek to gain complete ownership and eliminate the obligation of the revenue participation payments. It is the fifth anniversary of the capitalization, so the business entity's call right is now effective and it can unilaterally decide to acquire the investment entity's economic interest at the higher of the face value of the equity shares outstanding or a predetermined formula-based value. Preferably the formula-based value is based on the revenue of the business entity over a number of years, and may be determined by multiplying the business entity's average trailing twelve-month revenue for the preceding 36 months by 40%. Debt and unconverted preferred equity shares are then subtracted, while cash in excess of necessary working capital is added, to calculate the value of the business entity's common equity.

As one possible example, the formula-based value of the equity (in a Call or Put scenario) is calculated as follows:

| | | |
|---|---|---|
| $1,000,000 | | Avg. annual revenue in preceding 36 months |
| Times | 40% | Revenue valuation multiple per agreement |
| Equals | $400,000 | Enterprise Value |
| Plus | $87,500 | An estimate of Cash |
| Less | $0 | Debt |
| Equals | $487,500 | Formula equity value |
| Times | 31% | Investment entity's common equity interest |
| Equals | $150,279 | Business entity's payment to the investment |
| | | entity to redeem all the investment entity's |
| | | economic interest in the business entity. |

The face value of the equity shares is $92,750 ($300,000 initial equity capitalization times the remaining 31% equity interest). The face value is lower than the formula-based value so the equity transfer value is at the formula-based value.

When the business entity pays the investment entity $150,279 at the fifth anniversary of the capitalization, all of the investment entity's economic claims on the business entity are extinguished.

The business entity could have redeemed less than all of the equity shares, but for so long as any portion of the equity shares remains outstanding, the investment entity is entitled to the full share of revenue as prescribed by the RPS.

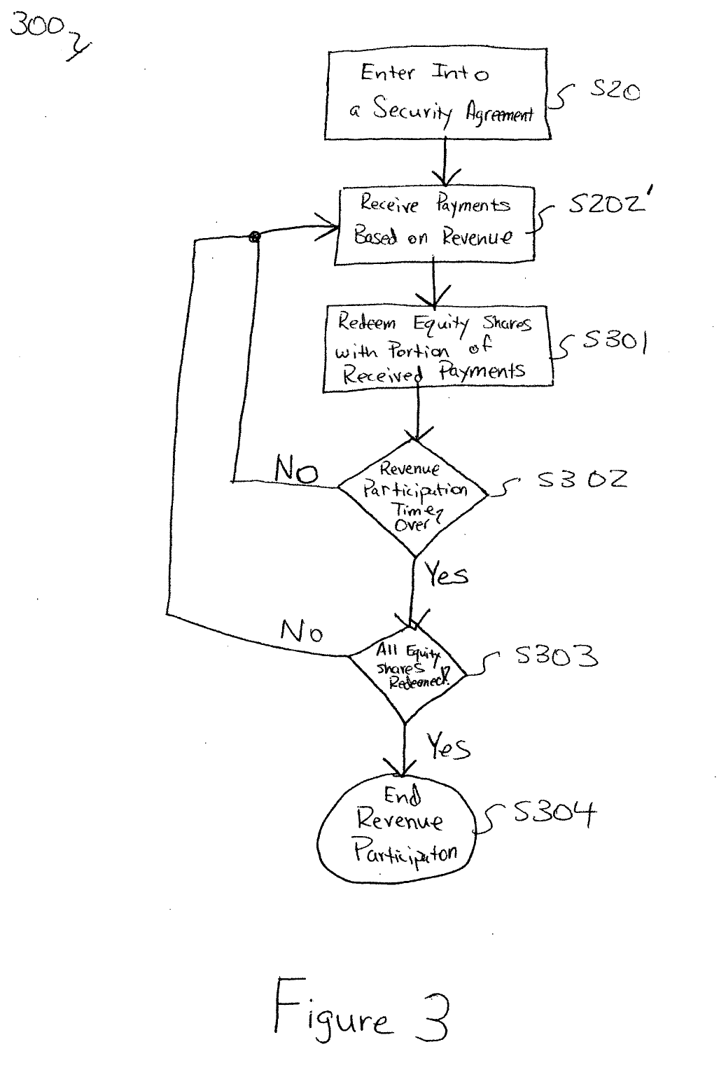

Returning to FIG. 2, slightly altered versions of the first two steps (S201, S202) in method 200 for monitoring and monetizing an investment security also comprise the first two steps of a method 300 for monetizing an investment security. As shown in FIG. 3, a method 300 for monetizing an investment security includes the steps of entering into a security agreement with a business entity, wherein the security agreement provides equity shares and a revenue participation right in exchange for capital (S201′), receiving a payment based on revenue in accordance with the revenue participation right (S202′), and redeeming a portion of the equity shares with a portion of the payment (S203).

Method 300 may also further include the step of retiring the revenue participation right (S304) after a predetermined length of time has expired (S302) and all provided equity shares have been redeemed (S303). As described above, the equity shares may be redeemed “naturally” through the equity redemption portion of the revenue participation payments or may be redeemed through a put/call option at the end of the predetermined length of time for revenue participation. If the revenue participation time has not expired or there are outstanding equity shares, the method returns to step S202′ and another revenue participation payment is received.

The method for monetizing an investment security shown in FIG. 3 and described above may be performed alone or may be incorporated with and/or preformed in conjunction with the method for monetizing and monitoring an investment security shown in FIG. 2.

Corporate Governance and Oversight Provisions in the Security Agreement

The security agreement may also provide for other contingencies that aid the investment entity in controlling or influencing corporate governance and oversight. Examples of possible corporate governance/oversight requirements that may be included in the security are described below:

Board of Directors—The holders of 51% of the equity shares will have the right to designate one observer to attend each meeting of the Board of Directors of the business entity. The 51% number may vary from agreement to agreement as desired.

Board Ascendancy Right—The holders of 51% of the preferred equity shares will have the right to elect a majority of the Board of Directors if (i) over a continuous 12-month period the business entity fails to achieve a predetermined income threshold; (ii) the business entity violates a negative covenant and fails to cure the violation in the prescribed period; (iii) the business entity is in arrears on RPS payments for any eighteen months; or (iv) the holder of the preferred equity shares ownership interest in the business entity is 90% or greater. Again, the 51%, 12-month, 18-month, and 90% numbers may vary from agreement to agreement as desired

Normal Dividends

The security agreement may also include provision concerning the payment of normal dividends to the investment entity. Normal dividends being dividends issued by the Board of Directors of the business entity and not the dividend portion of any RPS payments. The investment entity may not be entitled to receive any normal dividends paid by the business entity while the RPS remains outstanding. The business entity may pay dividends to holders of equity subordinate to investment entity's equity shares subject to certain negotiated restrictions.

For example, normal dividends may not be paid if:

1—Any revenue participation payment under the terms of the RPS that was not made when due in cash in the preceding year (during the preceding year all RPS payments must have been paid in cash on a timely basis);

2—The Board of Directors is not highly confident that for the projected twelve-month period subsequent to the normal dividend payment, the business entity will have adequate liquidity to fund all operating expenses and financing obligations, including all cash payments due to the investment entity whether deferrable or not deferrable;

3—Such normal dividends would exceed 50% of the non-operating cash balance of the business entity at the time of payment; this number may be different

4—The business entity is in default under the terms of any material operating or financial contract; or

5—A normal dividend was paid in the preceding 12 months. May be different number.

All numbers, lengths of time, and percentages in the previous example are exemplary only and any amounts may be used as desired.

Monitoring

Referring back to FIG. 2, after the payment based on revenue is received in step S202, a statement of fees paid to a third party is received (S203). The fees paid to third party are at least partly based on the revenue of the business entity. As discussed above, the third party is preferably a franchiser or licensor who is in a franchisor/franchisee or licensor/licensee relationship with the business entity. Because the franchisor or licensor has a monetary interest in the correctness of the revenue-based fee paid to them, the veracity of the revenue reported to them and the correctness of any revenue-based fee paid to them generally has greater validity than situations where businesses have no such oversight. Typically, franchisors and licensors have processes in place to monitor, oversee, and audit their franchisors and licensors. As such, the accuracy of the revenue-based payments made to the investment entity may be confirmed by checking the payment against revenue-based information or fees provided to such a third party licensor or franchisor. A copy of the revenue-based information provided to the third party may be forwarded to the investment entity in any form. Preferably, the information provided is a statement of the revenue-based fee paid to a third-party in the form of a copy of a cancelled check.

Additional monthly, quarterly, and yearly monitoring of the business entity by the investment entity may be employed. However, in the situation where the business entity is a franchised or licensed business, it is typical for a franchisor or licensor to already engage in substantial oversight and monitoring. In such a case, the only monitoring that may be desired by the investment entity is the comparison of the revenue-based payment with the revenue-based information/fee paid to the franchisor/licensor. Nevertheless, additional monitoring activities may also be useful.

Monitoring activities may include monthly, quarterly, and yearly reports concerning the financial records of the business entity, accounting for revenue participation payments and any associated redemptions of equity, accounting for partial revenue participation payments, and accounting for deferred revenue participation payments.

The outline below illustrates a work flow to complete some example reports.

Monthly Reports

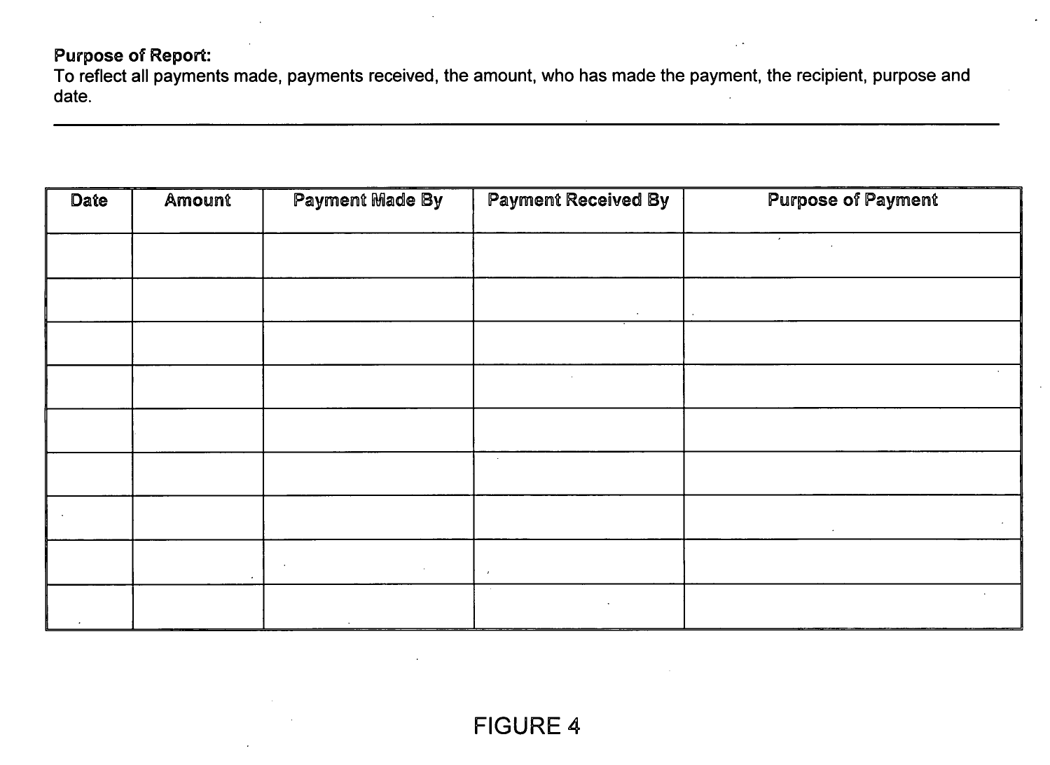

FIG. 4—This report is completed by the business entity to show cash flow between the business entity and the investment entity.

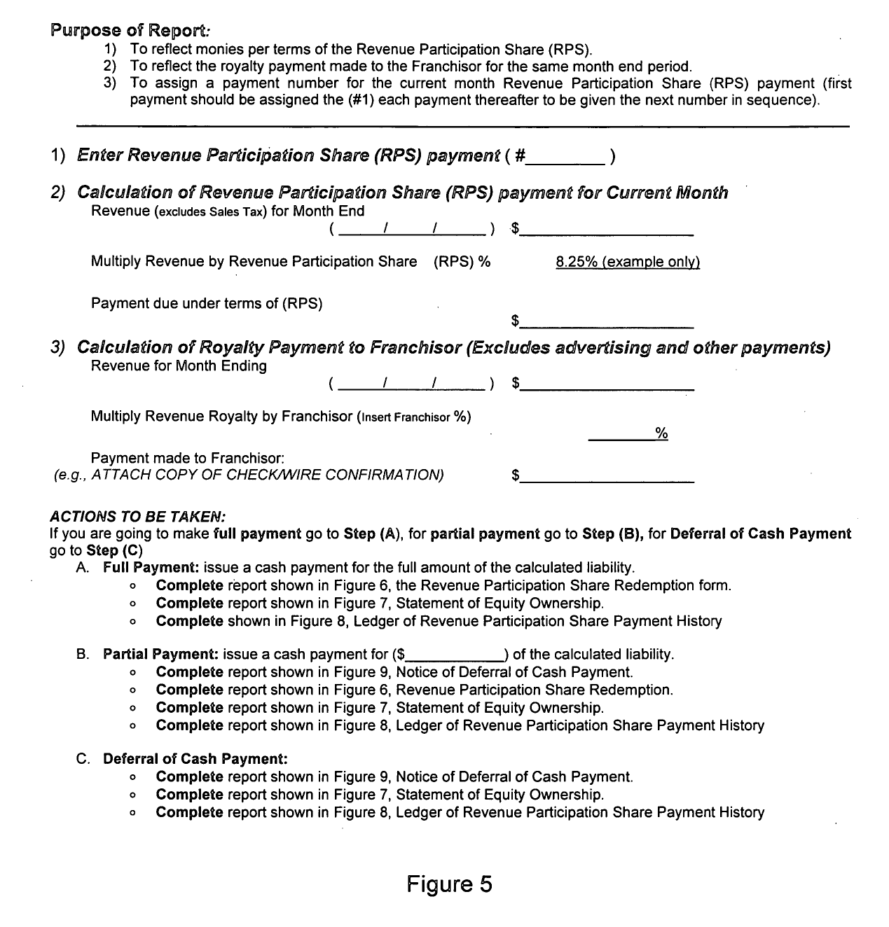

FIG. 5—The business entity uses this report to calculate the RPS payment due and then follow directions under the heading “ACTIONS TO BE TAKEN” to update the relevant schedules dependent on the possible variables identified below regarding payment of the Revenue Participation Share (RPS).

If Full Cash Payment:

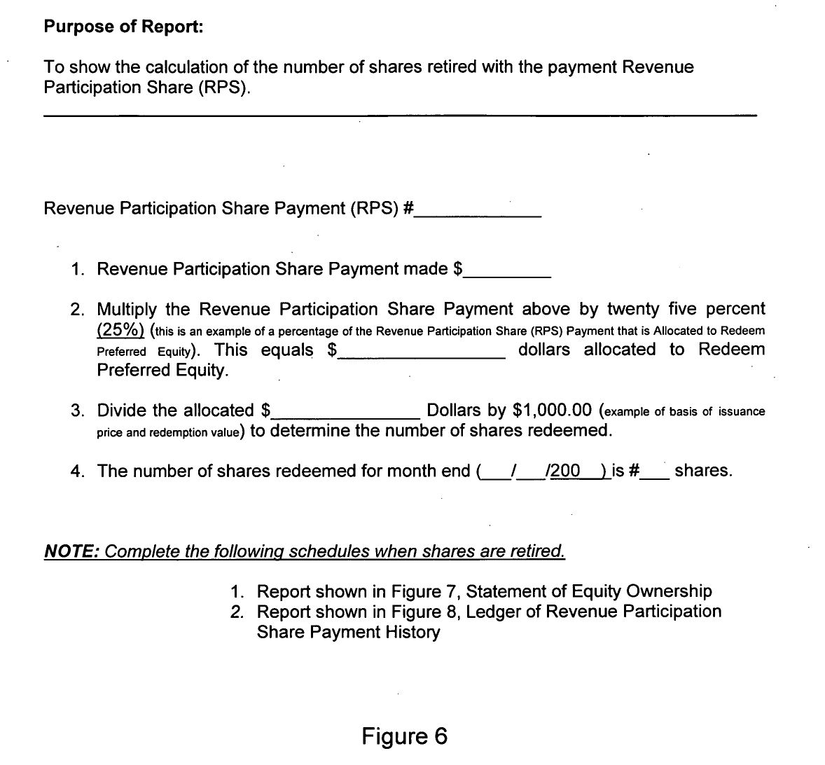

FIG. 6—The business entity completes this report to show the number of shares that are retired with a cash payment.

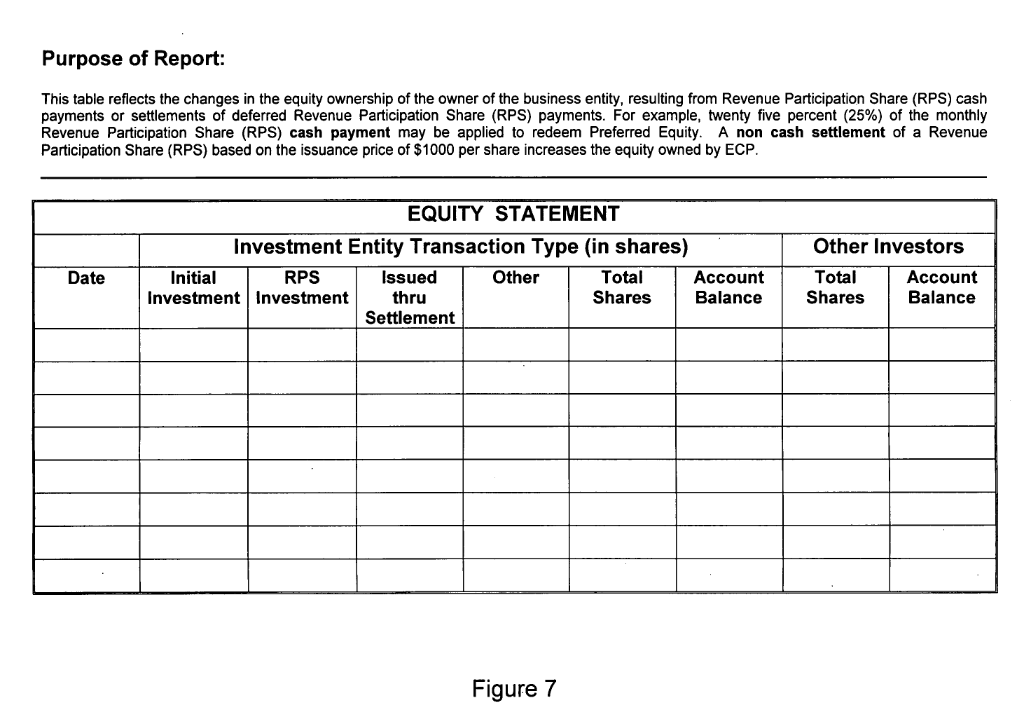

FIG. 7—The business entity completes this report to show the change in equity as a result of retiring shares.

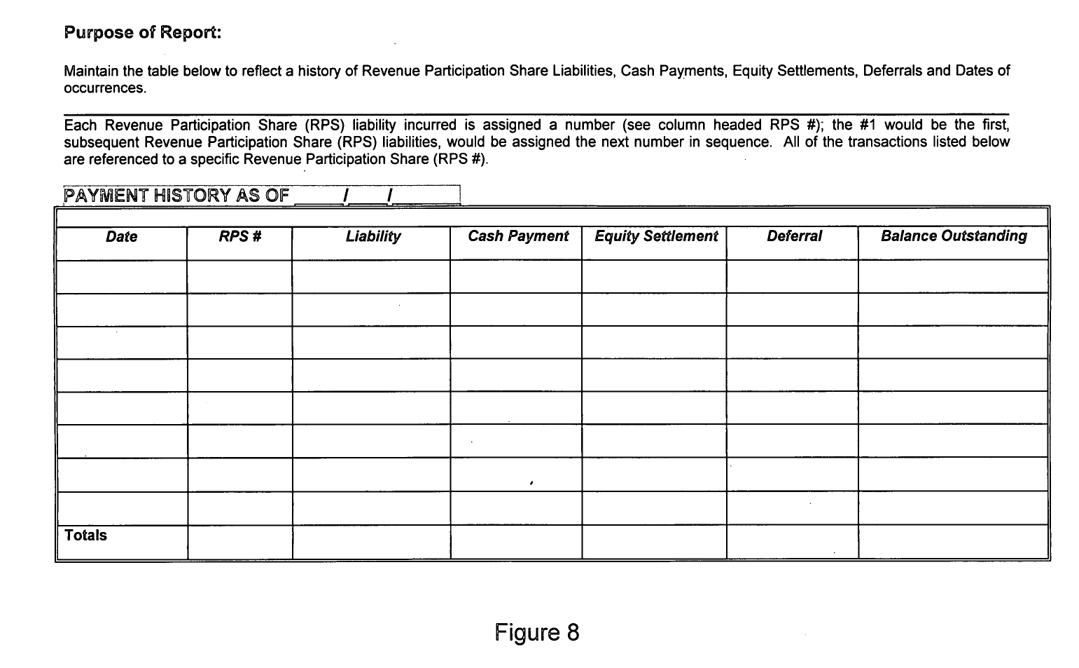

FIG. 8—The business entity completes this report to show the history of RPS activity, including liabilities, cash payments, equity settlements, deferrals and outstanding balance (if any) with dates.

If Partial Payment:

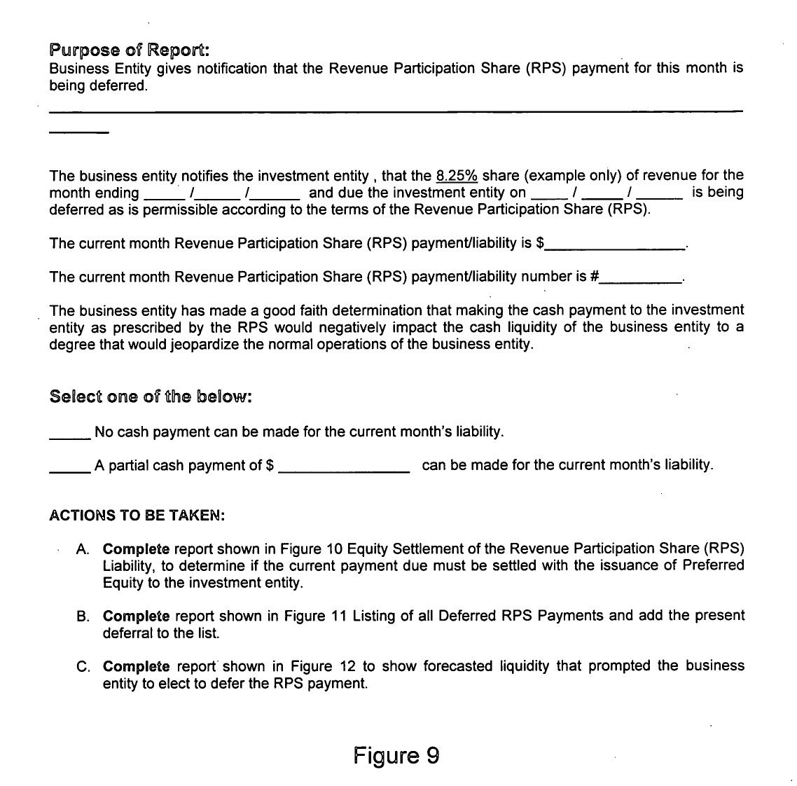

FIG. 9—The business entity completes this report to give notice that part of the RPS payment is being deferred.

FIG. 6—The business entity completes this report to show the number of shares that are retired with a cash payment.

FIG. 7—The business entity completes this report to show the change in equity as a result of retiring shares.

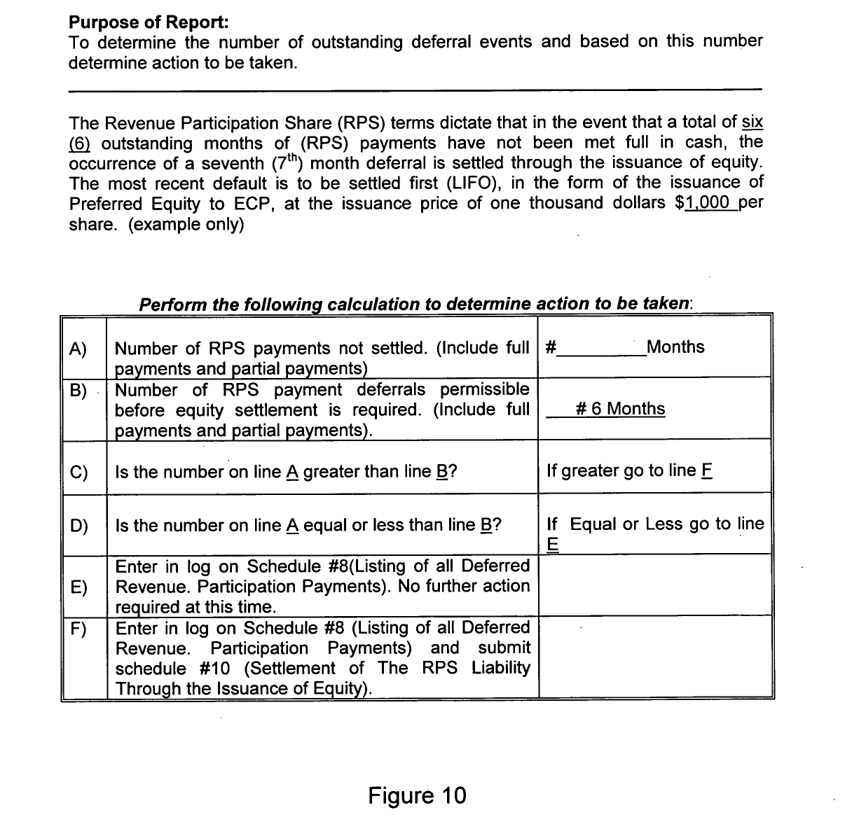

FIG. 10—The business entity completes this report to show the number of deferral events. The business entity may be directed to this report from the report shown in FIG. 9.

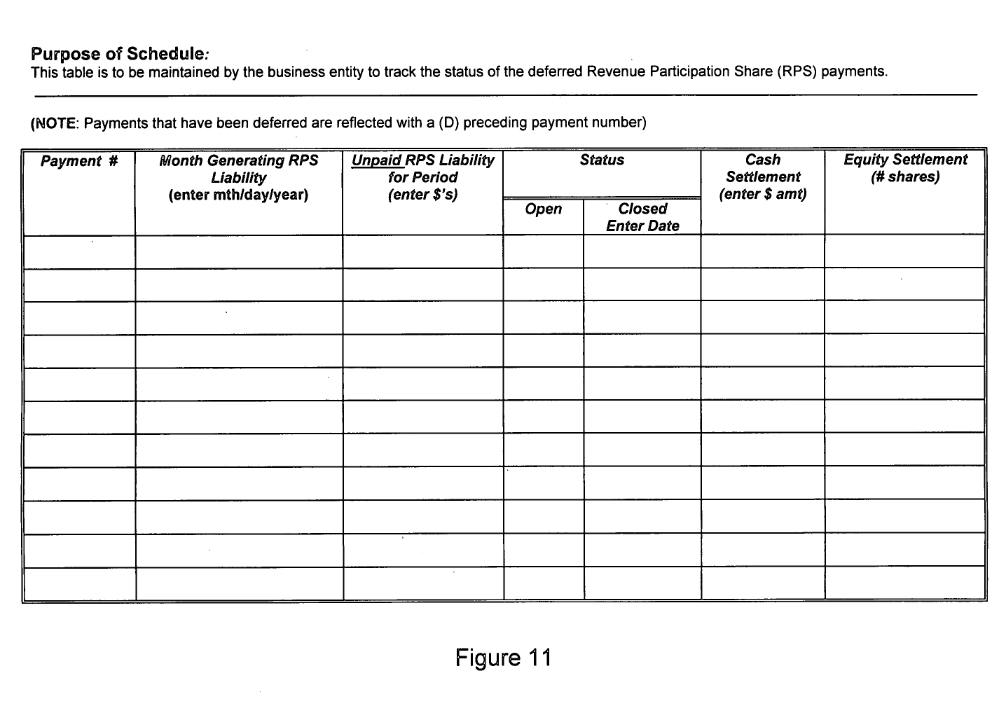

FIG. 11—The business entity completes this report to update the status of deferrals. The business entity may be directed to this report from the report shown in FIG. 9.

If Deferral of Cash Payment:

FIG. 9—The business entity completes this report to give notice that all of the RPS payment is being deferred.

FIG. 7—The business entity completes this report to show the change in equity as a result of retiring shares.

FIG. 8—The business entity completes this report to show the history of RPS activity, including liabilities, cash payments, equity settlements, deferrals and outstanding balance (if any) with dates.

FIG. 10—The business entity completes this report to show the number of deferral events. The business entity may be directed to this report from the report shown in FIG. 9.

FIG. 11—The business entity completes this report to update the status of deferrals. The business entity may be directed to this report from the report shown in FIG. 9.

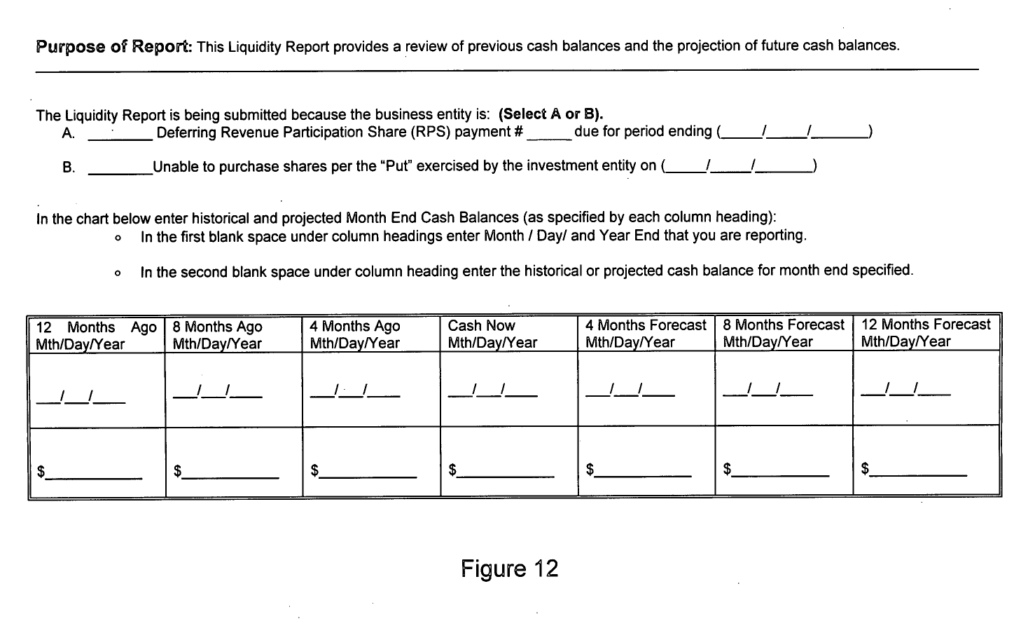

FIG. 12—The business entity completes this report to show a liquidity forecast. The business entity may be directed to this report from the report shown in FIG. 9.

Other Reports

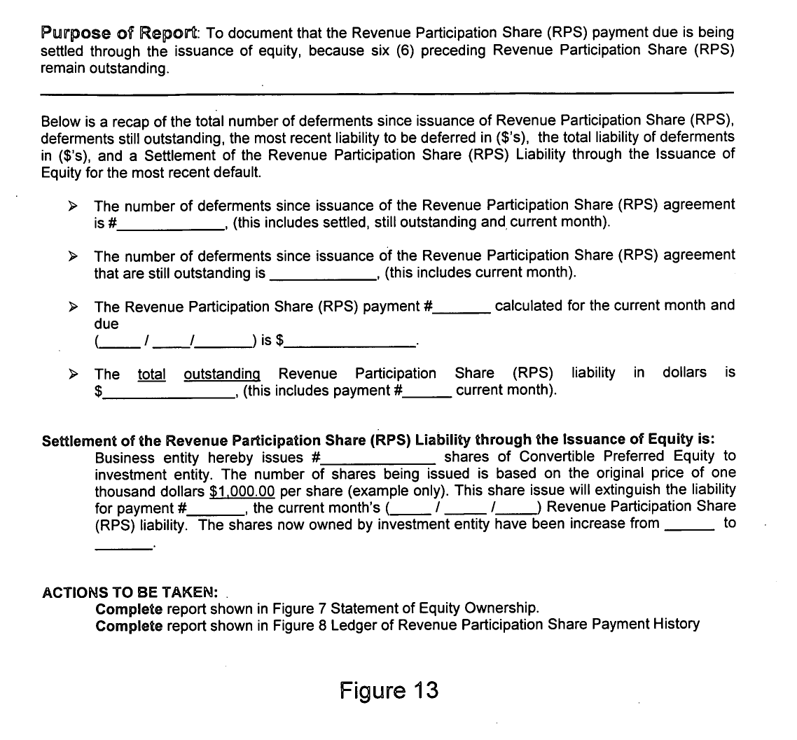

FIG. 13—The business entity completes this report when the Revenue Participation Share (RPS) payment is settled through the issuance of equity. Directions on this report may also request the business entity to complete the reports shown in FIGS. 7 and 8.

Other embodiments of the invention will be apparent to those skilled in the art from consideration of the specification and embodiments disclosed herein. Thus, the specification and examples are exemplary only, with the true scope and spirit of the invention set forth in the following claims and legal equivalents thereof.

What is claimed is:

1. A method for monitoring and monetizing an investment security comprising the steps of:
entering into a security agreement with a business entity, wherein the agreement includes a provision that specifies a schedule of one or more payments, the one or more payments being based on a revenue of the business entity;
receiving a payment of the one or more payments;
receiving a statement of fees paid to a third party by the business entity, wherein the fees paid to third party are at least partly based on the revenue of the business entity; and
comparing the fees paid to the third party to the received payment to confirm that the received payment is of an amount specified in the security agreement.

2. The method according to claim 1 wherein the one or more payments are received at predetermined intervals.

3. The method according to claim 2 wherein the statement of fees paid to a third party includes revenue information for the same interval for which received payment is made.

4. The method according to claim 1 wherein the security agreement is made between the business entity and an investment entity, and
wherein the agreement provides the investment entity with preferred stock and a revenue participation right in exchange for capital, the revenue participation right defining the one or more payments.

5. The method according to claim 4 wherein each of the one or more payments include a predetermined percentage of dividend and a predetermined percentage of equity redemption, wherein the predetermined percentage of equity redemption redeems the investment entity's preferred stock.

6. The method according to claim 5 wherein the one or more payments are made for the greater of a first predetermined length of time or a time when all of the investment entity's preferred stock has been redeemed by the equity redemption portion of the one or more payments.

7. The method according to claim 6 wherein the business entity has the option to purchase the remaining preferred stock of the investment entity at the end of the first predetermined length of time.

8. The method according to claim 6 wherein the investment entity has the option to sell their remaining preferred stock at the end of a second predetermined length of time.

9. The method according to claim 8 wherein the second predetermined length of time is longer than the first predetermined length of time.

10. A method for monetizing an investment security comprising the steps of
entering into a security agreement with a business entity, wherein the security agreement provides equity shares and a revenue participation right in exchange for capital;
receiving a payment based on revenue in accordance with the revenue participation right; and
redeeming a portion of the equity shares with a portion of the payment.

11. The method according to claim 10 wherein the payment is comprised of a dividend portion and an equity redemption portion, the equity redemption portion being used to redeem the equity shares.

12. The method according to claim 10 wherein the equity shares are preferred stock convertible into common stock.

13. The method according to claim 10 further comprising the step of:
retiring the revenue participation right after a predetermined length of time has expired and all provided equity shares have been redeemed.

14. The method according to claim 10 further including the step of:
selling outstanding equity shares to the business entity after the predetermined length of time has expired and all provided equity shares have not been redeemed.
